(19) United States
(12) Patent Application Publication
(10) Pub. No.: US 2004/0042769 A1
(43) Pub. Date: Mar. 4, 2004

(54) 2 in 1 portable optical disc player

(75) Inventor: Cheuk Lun Ng, Hong Kong (HK)

Correspondence Address: Thomas E. Sisson, JACKSON WALKER L.L.P., 112 E. Pecan Street, Suite 2100, San Antonio, TX, 78205, US

(73) Assignee: Oriental Spirit Industrial Ltd.

(21) Appl. No.: 10/234,282

(22) Filed: Sep. 4, 2002

(51) Int. Cl. H04N 5/781

(52) U.S. Cl. 386/125; 386/126

(57) ABSTRACT

A data-storage and presentation apparatus includes a user-control interface, a controller, a data-storage unit, a data-interfacing member, a control-signal interfacer, and a data-presentation unit. The user-control interface provides interfacing for a use to give control commands to the apparatus. The controller includes elements to detect the control commands from the user-control interface. The controller further sends control signals to an external data-retriever via the control-signal interface upon detection of a predetermined control command or a sequence of predetermined control commands at the user-control interface. Further yet, the controller controls the receipt of requested data from the external data-retriever and stores the requested data in the data-storage unit. Data stored in the storage means may be presented in audio format, video format, or a combination of video and audio formats.

### FIELD OF INVENTION

The invention relates to devices and apparatuses for retrieving data from optical storage medium such as compact discs (CD) video compact discs (VCD), digital versatile discs (DVD) and the like. This invention also relates to portable electronic devices and apparatuses for downloading data from optical storage medium for temporary storage and subsequent playback. This invention further relates to systems comprising an optical data retrieving apparatus and a detachable portable electronic device having means for downloading and storing the data retrieved by the optical data retrieving mechanism for subsequent playback, presentation or transfer. More specifically, although of course not solely limiting thereto, the present invention relates to a system including an optical reader or data-retrieving mechanism and a portable electronic apparatuses having means to control the operation of the optical and means for downloading the data retrieved from the optical disk for subsequent manipulation such as presentation or replay.

### BACKGROUND OF THE INVENTION

Optical data-storage medium such as optical discs have gained wide popularity in the last two decades. This widespread popularity is probably due to the low costs for manufacturing optical discs, the high reliability or fidelity of data-storage and retrieval as well as the ability to permit non-sequential access and retrieval of individually stored data files. Optical discs have been widely utilized as pure data-storage medium for the information industry. CD-ROM and CD-RW (readable/writable CDs) are well known examples of such data-storage medium.

Optical discs have also gained wide popularity and have become one of the mainstream data-storage medium for providing entertainment files to consumers. The entertainment files can be, for example, audio and/or video files such as music, photographs, movies, documentary recordings and animation files.

Despite their relatively short history, optical discs and the peripheral technologies have gone through drastic changes and evolution during the last decades. For example, movies in the earlier days were delivered in large 12-inch (30 cm) laser disks (LDs) which require a relatively bulky LD player to replay or present movies at home. Video compact discs (VCDs) having dimensions identical to a conventional 12-cm compact discs (CD) while containing as much information, if not more, as an old fashioned LD while providing comparable, if not better, picture quality became available. Consequently, compact VCD players are also available and became an important part of the audio-visual entertainment systems of many homes.

Subsequently, digital versatile discs (DVDs) which provide enhanced picture and sound quality on the same 12-cm compact discs while providing a significantly enhanced picture quality are also gaining increasing popularity as the price begins to go down. At the same time, new DVD formats such as EVD (enhanced video disc) and AVD (advanced versatile disc) formats have also been proposed to replace the conventional DVD format.

A similar, but less drastic, evolution has also occurred in the audio or music recording listens. A new audio recording format, known as super audio CD (SACD) has also appeared to provide enhanced music quality. In passing, other data formats, such as MP3, MD, MPEG and JPEG are also widely used in the meantime.

While the variety of recording and encoding formats provide a wealth of choices for the consumers, such formats inevitably require the appropriate corresponding data retrieving and presentation apparatuses to decode the data in order to deliver the entertainment information in a format comprehensible or enjoyable by the human listener and/or viewer. As more and more new formats for data compression and enhancement of picture and sound quality will be introduced, new players or data retrieving and presentation apparatuses will be required. This will further increase the number of types of optical players to be kept by a user while the user may only have a very limited choices when deciding to bring along a suitable player while on the move. Furthermore, the continual introduction of new formats means players for the old-format recordings only will become obsolete easily and quickly. Hence, it would be desirable if devices, apparatuses and systems for playing optical discs while alleviating the afore-said shortcomings can be provided.

### OBJECT OF THE INVENTION

In view of the afore-said shortcomings that are or will be expected to be associated with the future development of optical discs playback technologies, it is an object of the present invention to provide devices, apparatuses and possibly systems which can alleviate the afore-said shortcomings of existing optical disc playing apparatuses. Accordingly, it is at least an important aspect of the present invention to provide devices, apparatuses and possibly systems for playing or retrieving data from optical discs with lesser dependence on the recording format to alleviate the adverse consequences due to the rapid evolution of recording formats of optical discs. Further, it will be desirable if data from optical discs encoded in a variety of encoding formats can be downloaded to a portable device and can be played back while a user is on the move. At a minimum, the present invention seeks to provide the public with a choice of alternative devices, apparatuses and systems for playing or retrieving data for presentation from optical discs for the convenience and possibly benefits of the general public.

### SUMMARY OF THE INVENTION

According to a first aspect of the present invention, there is provided a data-storage and presentation apparatus including a user-control interfacing means, a control means, a data-storage means, a data-interfacing means, a control-signal interfacing means and a data-presentation means, the user-control interfacing means provides interfacing means for a user to give control commands to the apparatus, the control means includes means to detect the control commands from the user-control interfacing means, the control means includes means to send control signals to an external data-retrieving apparatus via the control-signal interfacing means to request for data transfer from the external data-retrieving apparatus upon detection of a pre-determined control command or a sequence of pre-determined control commands at the user-control interfacing means, the control means includes means to control receipt of requested data from the external data-retrieving means and to store the requested data in the data-storage means, the apparatus includes means to present data stored in the storage means in audio format, video format or a combination of video and audio formats.

According to a second aspect of the present invention, there is provided an optical data-retrieving apparatus including a main housing, an optical data-storage medium reading mechanism, control means, control-signal interfacing means and data-interfacing means, the control means controls optical reading of specified data from the data-storage medium reading mechanism upon receipt of pre-determined control signals from an external apparatus and via the control-signal interfacing means, the apparatus includes means to convert the optically read data into electrical data, the control means controls the transfer of the electrical data to the external apparatus via the data-interfacing means.

According to a third aspect, there is provided an optical disc playing system including a data-storage and presentation apparatus of the first aspect of this invention and an optical data-retrieving apparatus of a second aspect of this invention.

Preferably, apparatus includes means to detect whether an external data-retrieving apparatus is connected to the apparatus, the control signals to request for data transfer from the data-retrieving apparatus will not be transmitted via the control-signal interfacing means if the external data-retrieving apparatus is not connected.

Preferably, user-control interfacing means includes a pre-determined key or a sequence of pre-determined keys to present data, actuation of the predetermined key or the pre-determined sequence of keys will result in the presentation of the data stored in the data-storage means if data is not available from external data-retrieving apparatus or if the external data-retrieving apparatus is not connected to the apparatus.

Preferably, the user-control interfacing means includes a pre-determined key or a sequence of pre-determined keys to present data, actuation of the predetermined key or the pre-determined sequence of keys will result in the transfer of data from the data-retrieving apparatus to the data-storage means of the apparatus.

Preferably, the apparatus includes means to transfer data stored in the data-storage means to an external device via the data-interfacing means.

Preferably, the apparatus includes a main housing having means for mechanically securing and electrically connecting the apparatus with the external data-retrieving apparatus.

### BRIEF DESCRIPTION OF THE DRAWINGS

Preferred embodiments of the present invention will be explained in further detail by way of examples and with reference to the accompanying drawings, in which:

FIG. 1A is a perspective view showing a system comprising a data-storage and presentation apparatus connected with an optical data-retrieving apparatus of the present invention,

FIG. 1B shows the system of FIG. 1A with the constituting parts detached,

FIG. 2A shows a simplified schematic block diagram showing the construction and operation of the system of FIGS. 1A and 1B,

FIG. 2B is a more detailed circuit block diagram of FIG. 2A,

FIG. 3 is a flow chart showing an example of the operating procedures of the system of FIGS. 1A and 1B,

FIG. 4 is a flow chart showing the internal control procedure of the systems of FIGS. 1A and 1B,

FIG. 5 is a block diagram showing the signal flow of a first preferred embodiment of the system of FIGS. 1A and 1B for MP3 audio application, and

FIG. 6 is a block diagram showing the signal flow of a second preferred embodiment of the system of FIGS. 1A and 1B for VCD audio and video application.

### DETAILED DESCRIPTION OF THE PREFERRED EMBODIMENT

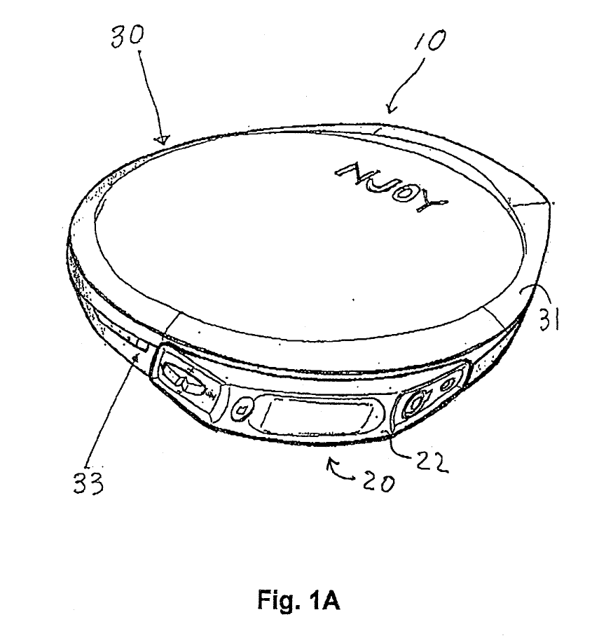

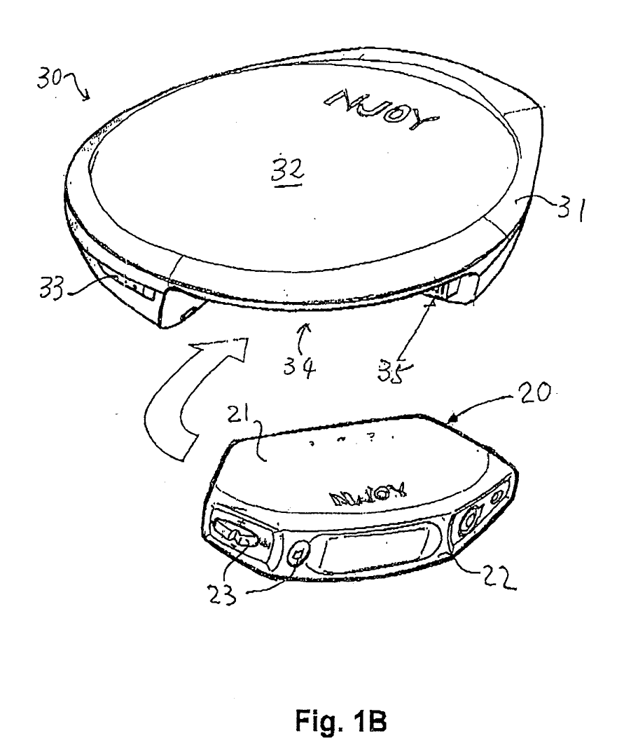

General construction of the present invention will be described by reference to FIGS. 1A and 1B. The system or combined optical disk player apparatus 10 includes a data-storage and playback (or presentation) apparatus 20 and an optical data-retrieving apparatus 30 which can be connected together both mechanically and electrically.

The data-storage and presentation (or playback) apparatus (referred to hereinafter as the “First Apparatus”) includes a main housing 21 with a control and display panel 22 disposed at the front portion of the main housing 21. A plurality of control keys, buttons and/or switches 23 as well as a display screen are disposed on the front control and display panel 22. The buttons, keys and switches 23, collectively referred to as the user-control interfacing means, provides means for a user to provide commands to the controller of this First Apparatus to control its operation as well as controlling the data-retrieval from the Second Apparatus. A data-interfacing means which can be, for example, an electrical data connector, are provided at the rear end or side of the main housing 21 for interfacing with the optical data-retrieving apparatus 30.

The optical data-retrieving apparatus 30, referred to as the “Second Apparatus” hereinafter, includes a main housing 31 containing an optical disk reading mechanism for data-retrieval from an optical disk placed within the main housing. The main housing 31 is preferably provided with a spring-bias hinged lid which can be released by a button 33. The optical reading mechanism can be a conventional optical reading mechanism with a laser source equipped with a lens to focus the laser beam onto the data encoding side of the optical disc and the data carrying reflected laser beam is then collected by an optical collector for conversion into digital electrical signal. To accommodate and to provide electrical and mechanical connection to the second apparatus, the First Apparatus is formed with an aperture or a compartment 34 which is shaped and dimensioned to closely fit the outer dimension of the First Apparatus when the First Apparatus is securely received within the aperture or compartment 34. A data-interfacing means and a control-signal interfacing means, which can be, for example, conventional electrical signal connectors 35, are provided on the periphery of the compartment 34 for making corresponding electrical contacts with the First Apparatus. A latch is also provided on the main housing to allow retention and release of the First Apparatus. The outer peripheral wall of the main housing 31 of the Second Apparatus is preferably designed so that there is an overall continuity between the outer peripheral wall of the Second Apparatus and the front control and display panel of the First Apparatus as shown in FIG. 1 for style and aesthetic consideration.

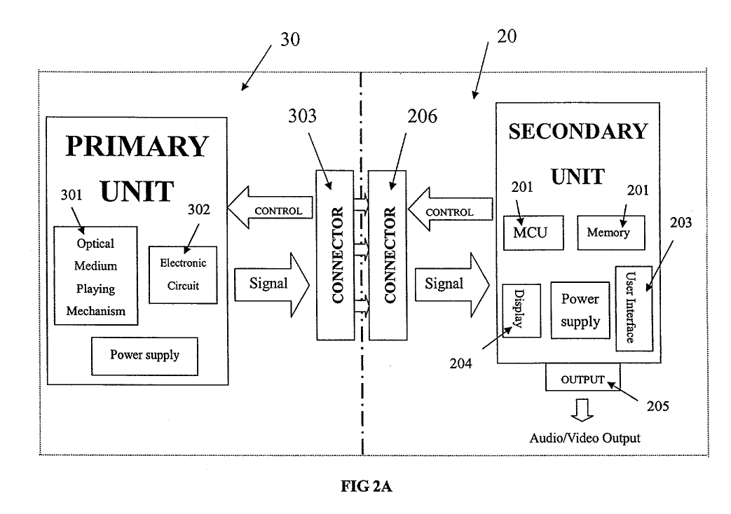

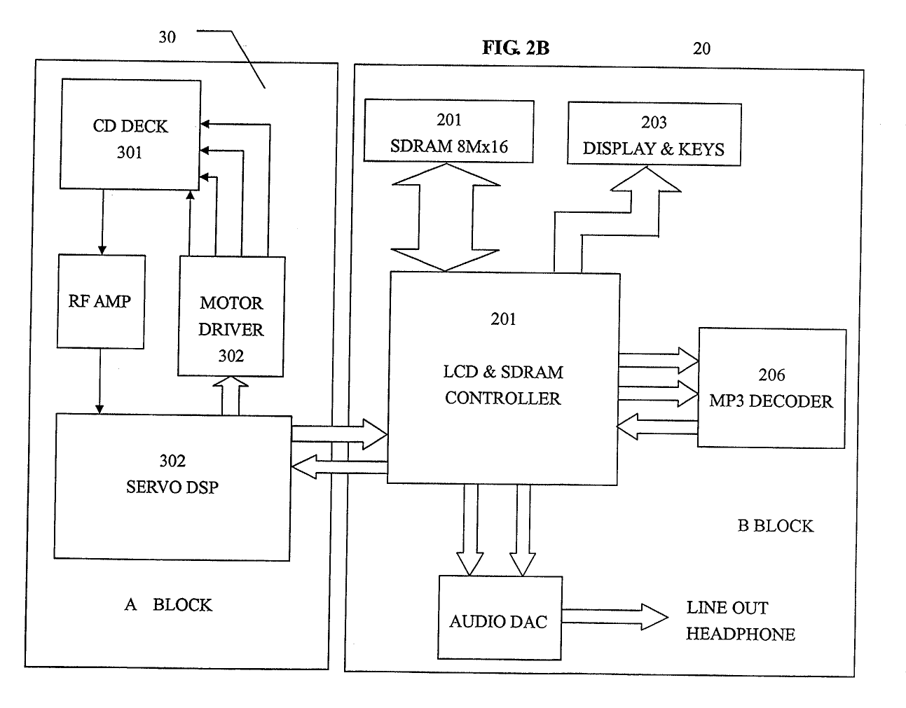

Referring now to the simplified block diagram of FIG. 2A and the more detailed circuit block diagram of FIG. 2B, a general, broader, concept of the present invention will be described. Referring firstly to 2A, the First Apparatus includes a control means 201 which can be a micro-controller (MCU), a data-storage means 202 which can be a re-writable memory such as DRAM, SRAM or Flash Memory, user-control interfacing means which may include a plurality of keys, buttons or switches 23, a display means 204 such as a LED display and a signal output means 205 which can be output jack or connector 25.

The Second Apparatus includes an optical disc reader which is controlled by electronic circuitry 302 for signal retrieval and transfer towards the First Apparatus via the connector 303.

An example of the operation of the combined apparatus will be briefly explained with reference to FIGS. 2A and 2B below. When a user provides specific instructions to the First Apparatus 20 for the retrieval of a specific file, for example, a certain track, from an optical disc stored in the Second Apparatus 30, the control means 201, which is a MCU, upon detection of such instructions will transmit the appropriate corresponding commands to the electronic circuitry 302 of the Second Apparatus 30 via the electrical connectors 206 and 303. Upon receipt of the instructions from the First Apparatus 20, the electronic circuitry 302 of the Second Apparatus 30 will cause the optical mechanism 301 to retrieve the desirable data file from the optical disc currently placed on the optical reading mechanism 301. The retrieved data will be transferred to the First Apparatus via the data interfacing means 303, 206 respectively of the Second and First Apparatuses. The MCU 201 will then cause the received data file to be stored in the data-storage means 201 for playback, presentation or subsequent utilization. To alleviate the shortcomings associated with conventional optical disc players in view of the rapidly emerging new data formats, the electrical data output reported from the Second Apparatus in the present invention are preferably in the form of pre-decoded or encoded electrical signals and the decoding will be performed by a decoding means 206 disposed in the First Apparatus.

As the data received from the Second Apparatus is substantially un-decoded raw electrically converted optical signals which may be in one of the encoding formats such as CD, VDC, MD, MP3, JPEG, MPEG, DVD or similar formats, the data will have to be decoded before they can be output in a comprehensible format to a human listener or viewer. This is done by the decoding means 206 connected with the micro-controller 201 before the signal is converted to a comprehensive form, for example, analogue audio or video signals for output. The decoded data file can be stored on the data-storage means 201 for future playback or it can be stored in the encoded form to be decoded when there is a request for replay next time. The MCU may be equipped with means to detect the type of data encoding of formatting to provide the corresponding decoding or data transformation. To further alleviate the shortcomings of conventional optical disc players which are unable to deal with new encoding formats, the First Apparatus may be provided with means to learn new encoding formats and to provide means for decoding new formats. This may be done, for example, by adding a self-learning procedure in the MCU and providing extra memory space for installing new programmes or steps for dealing with new data encoding formats.

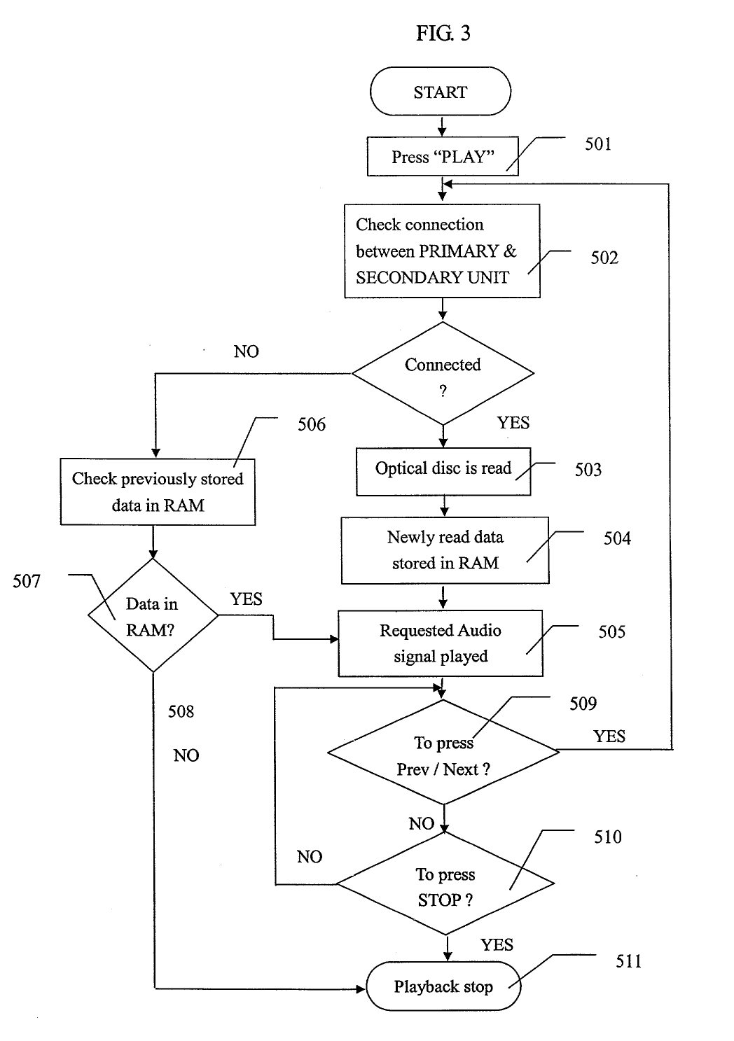

Referring now to the flow chart of FIG. 3 showing a preferred example of the operating procedures of the combined apparatus 10 FIGS. 1A and 1B.

When a user press a specific control button on the control panel 22 of the First Apparatus 20 which is the “PLAY” button in the present example, as represented by step 501, the playback operation will be initiated. Upon detection of the pressing of the “PLAY” key, the MCU will determine in step 502 whether the Second Apparatus is connected to the First Apparatus. Of course, this command can conclude a sequence of steps such as “PLAY” “N”, where N is the number of tracks.

If the result is positive, that is, the Second Apparatus is connected, the MCU will progress to step 503 to send control signals via the control-signal interfacing means to the control circuitry 302 of the First Apparatus 20 to request reading of the optical disc and data retrieval. When the requested data have been received from the optical disc, these requested data are stored in the data-storage means 201 of the First Apparatus as in step 504 and the encoded data will be decoded and replayed in step 505.

On the other hand, if the Second Apparatus is not connected to the First Apparatus, the MCU will progress to step 506 and check whether there are any data already stored in the data-storage means 201. If there are data present in the data-storage means 201, the MCU will progress to step 507 and retrieve the relevant data for replaying according to step 505. If there are no data stored in the data-storage means 201 and, since the optical disc player is not connected, no useful data will be available and the MCU will progress to step 508 to terminate operation and proceeding to step 511.

When the selected data file, such as a song or music, are being played as in step 505 and when another specific button such as “PREV/NEXT” is pressed, the MCU will perform the next data-retrieval by going back to step 502 to select the previous or next track, whether stored in the optical disc or in the data-storage memory, depending whether the Second Apparatus is connected and according to the flow chart. If the “PREV/NEXT” button is not pressed during the playing of the requested data, the MCU will keep searching whether the “PREV/NEXT” button has been pressed and will proceed to termination if the “STOP” button is pressed.

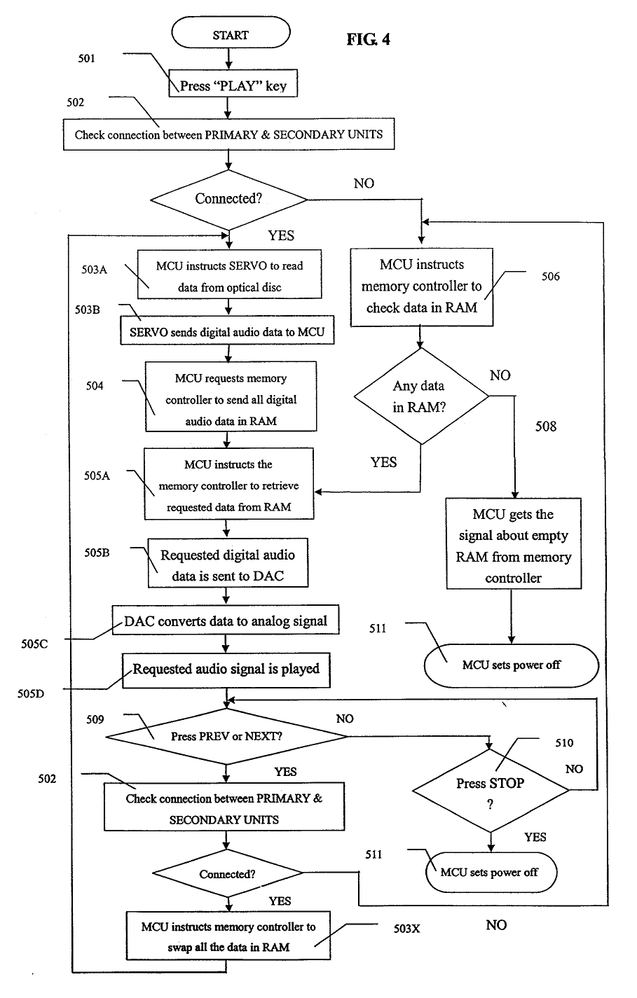

Referring now to FIG. 4, a more detailed flow chart showing the internal operation of the apparatus with particular emphasis on the internal procedures for data-retrieval from the optical disc and the utilization or playback of the stored data from the data-storage means 201 will be described in more detail. In general, this flow chart is similar to that of FIG. 3 and the major differences will be explained. Referring firstly to steps 503A and 503B, the optical data disc is read. This is done with the MCU first instructing the servo circuitry to read data from optical disc as shown in step 503A. The servo circuitry will then transfer the retrieved data to the MCU 201 as shown in step 503B.

Turning now to the steps 505A-505D for a more detailed explanation for audio playback of the retrieved data, the MCU 201 will first instruct the memory controller to retrieve the requested data from the data-storage means 201 as shown in step 505A. The requested digital data are then decoded and forwarded to a digital-to-analogue (“DAC”) circuitry for conversion into a human comprehensible format as shown in steps 505B and 505C. The analogue audio sound is then replayed as shown in step 505D.

Upon detection of the press of the button “PREV/NEXT”, the MCU will then check for the connection of the Second Apparatus 30. If the Second Apparatus is connected, the MCU can expect to receive a fresh set of data from the optical disc and will be prepared as shown in step 503 to overwrite the data already stored in the data-storage means 201.

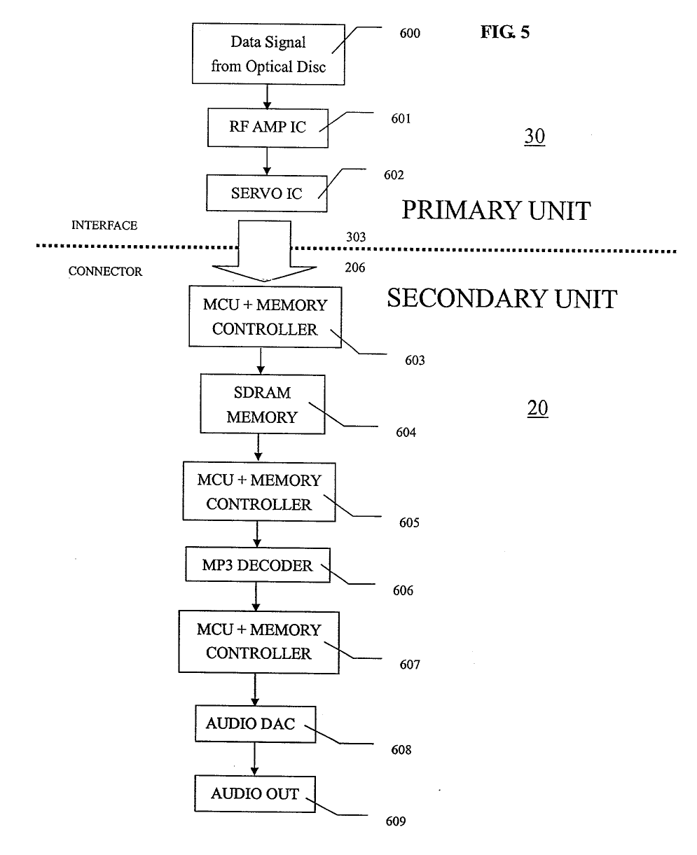

Referring now to the signal flow diagram of FIG. 5 relating more particularly to the retrieval of the optically stored data and the subsequent conversion into electrical data for storage and utilization, it will be noted from block 601 that the electrical signal obtained by the optical reading the optical disc will be amplified before going through a servo digital signal processing integrated circuit for onward transmission to the First Apparatus via data interfacing means 303 and 206 respectively of the Second and the First Apparatuses as shown in block 603. The retrieved data are then transferred to the data-storage means 201 as shown in block 604. The stored data will be retrieved for utilization as shown in block 605. Naturally, where the data are stored in the data-storage means 201 without decoding, the stored data will have to be decoded first as shown in step 606 before being presented to the human listener or viewer. The MCU will then store the decoded data in a temporary data-storage area as shown in block 607. The decoded data will then be transferred to a DAC for reconstructing as an analogue signal as shown in block 608 and for audio output as shown in block 609.

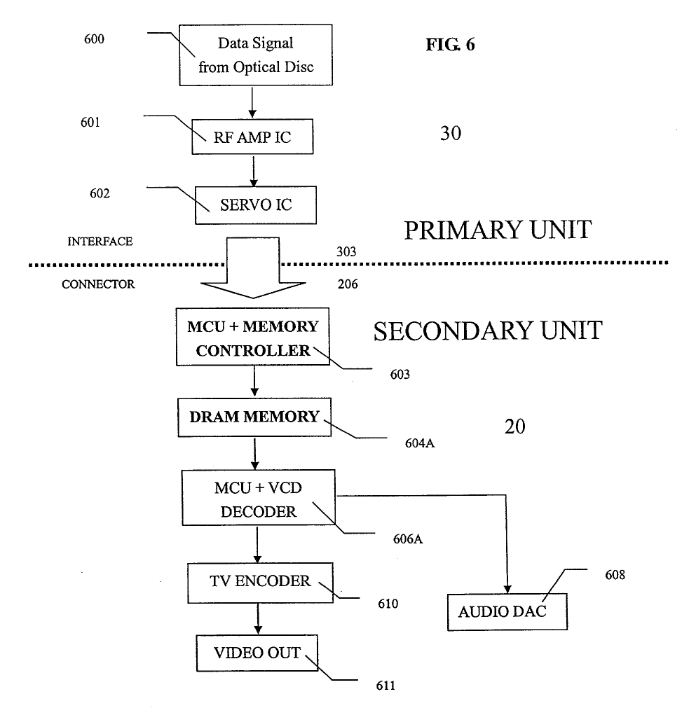

The signal flow block diagram of FIG. 6 is a slight modification of the flow chart of FIG. 5. Therefore, only the parts that are different will be explained. Referring to FIG. 6, it will be noted that dynamic rams (DRAM) are used as the memory cells for the data-storage means 201 and the preferred decoder example is compatible with the VCD encoding format. As both audio and video signal outputs will be generated from the VCD format, the data signals are split into an audio path as shown in block 608 and a video path for forwarding to a television encoder 610 for analogue video output 611.

From the above preferred examples, it will be appreciated that only slight modifications are required to be introduced in the First Apparatus in order to be able to replay audio signal only or to replay both audio and video signals. Also, it would be appreciated that only slight modifications need to be introduced into the First Apparatus to introduce additional or new data encoding and decoding formats and algorithms. In this the First Apparatus can be kept updated by just replacing or updating the critical functional modules. Furthermore, the detachability of the First Apparatus and the Second Apparatus means that the First Apparatus can be used irrespective of the type of data encoding of the optical disc being read by the optical reading mechanism of the Second Apparatus, so long as a compatible decoding mechanism is provided in the First Apparatus. The detachability also provides additional flexibility in that the First Apparatus can download optically read data from different compatible optical reading mechanisms irrespective of the data formatting and the sizes of the optical discs so that a user can download whatever form of entertainment files are available from whatever types of optical discs as and when desired.

While the present invention has been explained by reference to the preferred embodiments described above and with reference to the MD3 and VCD formats, it will be appreciated that the embodiments are only examples provided to illustrate the present invention and are not meant to be restrictive on the scope and spirit of the present invention. This invention should be determined from the general principles and spirit of the invention as described above. In particular, variations or modifications which are obvious or trivial to persons skilled in the art, as well as improvements made on the basis of the present invention, should be considered as falling within the scope and boundary of the present invention. Furthermore, while the present invention has been explained by reference to an audio/video player and a portable apparatus for downloading optically stored data from the optical discs, it should be appreciated that the invention can apply, whether with slight or major modification, to other types of devices, apparatuses or systems compatible with optical disk data-retrieving mechanisms.

### Reference Number List

20 playback representation apparatus (First Apparatus)

21 main housing

22 display panel

23 control keys, buttons and/or switches

25 connector

30 optical data-retrieving apparatus (Second Apparatus)

31 main housing

33 button

34 compartment

35 conventional electrical signal connector

201 control means

202 data-storage means

204 display means

205 signal output means

206 electrical connector

301 optical reading mechanism

302 electronic circuitry

303 connector

1. A data-storage and presentation apparatus including a user-control interfacing means, a control means, a data-storage means, a data-interfacing means, a control-signal interfacing means and a data-presentation means, said user-control interfacing means provides interfacing means for a user to give control commands to said apparatus, said control means includes means to detect said control commands from said user-control interfacing means, said control means includes means to send control signals to an external data-retrieving apparatus via said control-signal interfacing means to request for data transfer from said external data-retrieving apparatus upon detection of a pre-determined control command or a sequence of pre-determined control commands at said user-control interfacing means, said control means includes means to control receipt of requested data from said external data-retrieving means and to store said requested data in said data-storage means, said apparatus includes means to present data stored in said storage means in audio format, video format or a combination of video and audio formats.

2. An apparatus according to claim 1, wherein said apparatus includes means to detect whether an external data-retrieving apparatus is connected to said apparatus, said control signals to request for data transfer from said data-retrieving apparatus will not be transmitted via said control-signal interfacing means if said external data-retrieving apparatus is not connected.

3. An apparatus according to claim 1, wherein said user-control interfacing means includes a predetermined key or a sequence of predetermined keys to present data, actuation of said pre-determined key or said pre-determined sequence of keys will result in the presentation of the data stored in said data-storage means if data is not available from external data-retrieving apparatus or if said external data-retrieving apparatus is not connected to said apparatus.

4. An apparatus according to claim 1, wherein said user-control interfacing means includes a pre-determined key or a sequence of predetermined keys to present data, actuation of said pre-determined key or said predetermined sequence of keys will result in the transfer of data from said data-retrieving apparatus to said data-storage means of said apparatus.

5. An apparatus according to claim 1, wherein said apparatus includes means to transfer data stored in said data-storage means to an external device via said data-interfacing means.

6. An apparatus according to claim 1, wherein said external data-retrieving apparatus includes a mechanism for reading data from an optical storage medium such as an optical disc.

7. An apparatus according to claim 6, wherein said data transferred from said external data-retrieving apparatus includes data in MP3, MD, CD, SACD, VCD, DVD or like encoding formats.

8. An apparatus according to claim 1, wherein said data-storage means includes re-writable electronic storage devices such as DRAM, SRAM, Flash Memory or the like.

9. An apparatus according to claim 1, wherein said control means includes means to detect the encoding format of stored data and to present said data in the appropriate format.

10. An apparatus according to claim 1, wherein said apparatus includes a main housing having means for mechanically securing and electrically connecting said apparatus with said external data-retrieving apparatus.

11. An optical data-retrieving apparatus including a main housing, an optical data-storage medium reading mechanism, control means, control-signal interfacing means and data-interfacing means, said control means controls optical reading of specified data from said data-storage medium reading mechanism upon receipt of pre-determined control signals from an external apparatus and via said control-signal interfacing means, said apparatus includes means to convert said optically read data into electrical data, said control means controls the transfer of said electrical data to said external apparatus via said data-interfacing means.

12. An apparatus of claim 11, wherein said control means includes a servo mechanism to control data reading from an optical medium stored in said optical data-storage medium reading mechanism.

13. An apparatus of claim 11, wherein said optical data-storage medium reading mechanism is compatible for reading data from optical discs encoded in MP3, MD, CD, SACD, VCD, DVD and the like formats, whether one type or in a combination of formats.

14. An apparatus of claim 11, wherein said electrical data are amplified before being transferred to said external apparatus.

15. An apparatus of claim 11, wherein said main housing includes means for mechanically securing and electrically connecting with said external apparatus and means.

16. An electronic system including a first apparatus of claim 1 and a second apparatus of claim 11 wherein said first and second apparatus being electrically and mechanically detachable.

17. A system of claim 16, wherein said second apparatus includes means to retrieve data from an optical disc upon detection of a pre-determined command or a sequence of commands from said first apparatus and received via said control-signal means of both said first and second apparatuses, said retrieved data are then transferred to said data-storage means of said first apparatus via said data-interfacing means of both said first and second apparatuses.

18. A system of claim 17, wherein upon detection of a pre-determined command or a sequence of commands from said user-interfacing means, said first apparatus will examine whether data are available from said data-storage means and will present information stored in said data-storage means in a format comprehensible or appreciable by the human listener or viewer if the examination result is positive.
